(19) United States
(12) Patent Application Publication
(10) Pub. No.: US 2011/0085724 A1
(43) Pub. Date: Apr. 14, 2011

(54) APPLICATION STATE INSPECTING METHOD

(75) Inventors: Shinji SASAGURI, Osaka (JP); Tadashi SHINOZAKI, Yamanashi (JP); Naoki YAMAUCHI, Yamanashi (JP)

(73) Assignee: PANASONIC CORPORATION, Osaka (JP)

(21) Appl. No.: 12/897,976

(22) Filed: Oct. 5, 2010

(30) Foreign Application Priority Data
Oct. 8, 2009 (JP) 2009-234038

(51) Int. Cl. G06K 9/00

(52) U.S. Cl. 382/145

(57) ABSTRACT

A paste Pst applied onto a substrate Pb in a predetermined drawing pattern is imaged to acquire the image (step ST1), the outline G of the paste Pst applied onto the substrate Pb is extracted on the basis of the acquired image (step ST2), and the outline length of the paste Pst is calculated from the extracted outline G of the paste Pst (step ST3). The calculated outline length of the paste Pst is compared with a reference range of the outline length determined depending on the drawing pattern of the paste Pst, it is determined whether the outline length of the paste Pst is in the reference range (steps ST4 to ST6), and the application state of the paste is determined (steps ST7 and ST8).

### BACKGROUND OF THE INVENTION

1. Field of the Invention

The present invention relates to an application state inspecting method of inspecting an application state of a viscous material applied onto an application target such as a substrate.

2. Description of the Related Art

In a paste applying step before a die bonding step in manufacturing a semiconductor device, a viscous material such as a bonding paste as an adhesive used to bond a semiconductor chip onto an application target such as a substrate is applied by a dispenser. It is necessary to apply an appropriate amount of the viscous material onto the application target in a predetermined drawing pattern. Accordingly, after the drawing operation of the dispenser, it is inspected (an application state is inspected) whether the viscous material has been applied onto the application target in accordance with a predetermined drawing pattern. The inspection of the application state is typically carried out by capturing an image of the viscous material applied onto the application target with a camera, recognizing the acquired image on the basis of the detection of brightness, and determining whether the viscous material applied onto the application target is inside predetermined inspection lines (for example, see Patent Document 1) or determining whether the area of the viscous material on the application target is in the reference range.
Patent Document 1: JP-A-2003-4661

However, in the inspection method, when the viscous material is an easily-spreading material, the spreading speed of the viscous material is high even after an appropriate amount of viscous material is applied onto the application target, and thus the viscous material goes over the inspection lines, whereby the application state may be determined as being not good at the time of inspection. Some examples of the viscous material include a material making the reflection of light in a central top portion of the paste applied onto the application target be uneven and an applied area in such a viscous material may be recognized as a non-applied area. Accordingly, it may not be possible to obtain an accurate inspection result using the inspection method of comparing the area of the viscous material on the application target with a reference range.

### SUMMARY OF THE INVENTION

Therefore, it is an object of the invention to provide an application state inspecting method which can acquire an accurate inspection result of an application state onto an application target even when a viscous material is an easily-spreading material or a material easily making the reflection of light uneven.

According to an aspect of the invention, there is provided an application state inspecting method of inspecting an application state of a viscous material applied onto an application target in a predetermined drawing pattern, including the steps of: capturing an image of the viscous material applied onto the application target and acquiring the image; extracting an outline of the viscous material applied onto the application target on the basis of the acquired image; calculating an outline length of the viscous material from the extracted outline of the viscous material; comparing the calculated outline length of the viscous material with a reference range of the outline length determined depending on the drawing pattern of the viscous material and determining whether the outline length of the viscous material is in the reference range; and determining the application state of the viscous material on the basis of the determination result of whether the outline length of the viscous material is in the reference range.

According to the invention, since the outline of the viscous material applied onto the application target is extracted on the basis of the image acquired by capturing the viscous material applied onto the application target in a predetermined drawing pattern and the application state of the viscous material is determined on the basis of whether the outline length of the viscous material calculated from the extracted outline of the viscous material is in the reference range of the outline length determined depending on the drawing pattern of the viscous material, it is possible to obtain an accurate inspection result of the application state of the viscous material on the application target even when the viscous material is an easily-spreading material or a material making the reflection of light uneven.

### BRIEF DESCRIPTION OF THE DRAWINGS

FIG. 1 is a block diagram illustrating the configuration of a paste applying device according to an embodiment of the invention.

FIG. 2 is a diagram illustrating an example of a paste applied on a substrate by the paste applying device according to the embodiment of the invention.

FIG. 3 is a flowchart illustrating a flow of an application state inspecting method according to an embodiment of the invention.

FIGS. 4(a) and 4(b) are diagrams illustrating a variation of the paste applied onto the substrate by the paste applying device according to the embodiment of the invention.

FIGS. 5(a) and 5(b) are diagrams illustrating an application state determining method employed by the application state inspecting method according to the embodiment of the invention.

### DESCRIPTION OF THE PREFERRED EMBODIMENTS

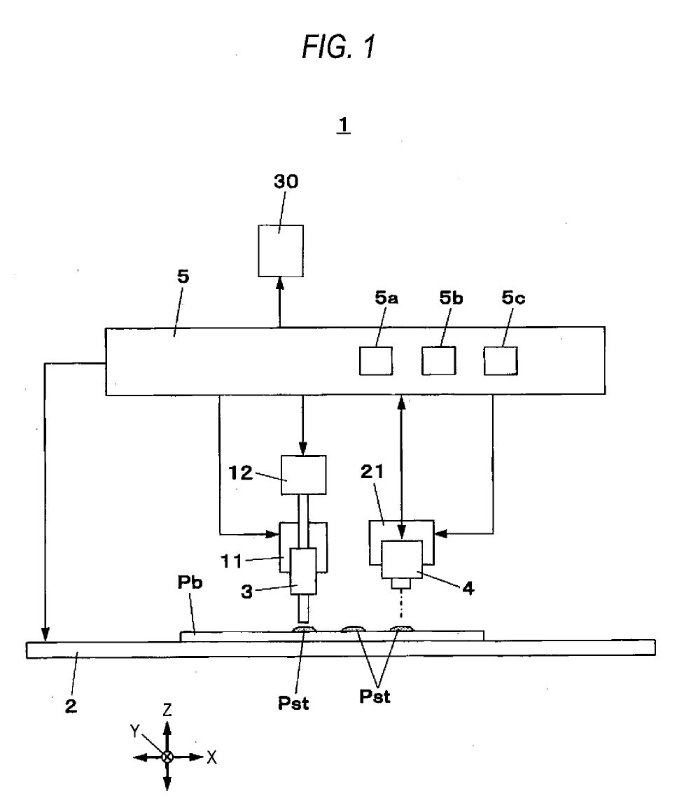

Hereinafter, embodiments of the invention will be described with reference to the accompanying drawings. A paste applying device 1 shown in FIG. 1 includes a substrate carrying path 2 carrying a substrate Pb (application target) onto which a bonding paste (hereinafter, referred to as “paste”) Pst as a viscous material is applied, a dispenser 3 ejecting the paste Pst onto the substrate Pb carried by the substrate carrying path 2, a camera 4 capturing an image of the substrate Pb onto which the paste Pst is applied by the dispenser 3, and a controller 5 controlling the operations of the paste applying device 1.

The substrate carrying path 2 is formed of a belt conveyor or the like and carries the substrate Pb in the horizontal in-plane direction under the operation control of the controller 5. Hereinafter, for the purpose of convenient explanation, the carrying direction of the substrate Pb by the substrate carrying path 2 is defined as an X axis direction, the in-plane direction perpendicular to the X axis is defined as a Y axis direction, and the vertical direction is defined as a Z axis direction.

The dispenser 3 moves in the X axis direction, the Y axis direction, and the Z axis direction with the operation of a dispenser moving mechanism 11 constructed by an orthogonal triaxial robot and ejects the paste Pst with the operation of a dispenser driving mechanism 12. The operations of the dispenser moving mechanism 11 and the dispenser driving mechanism 12 are controlled by the controller 5.

The camera 4 moves in the X axis direction, the Y axis direction, and the Z axis direction with the operation of a camera moving mechanism 21 constructed by an orthogonal triaxial robot. The operation of the camera moving mechanism 21 and the imaging operation of the camera 4 are controlled by the controller 5. Image data acquired by the imaging of the camera 4 is input to the controller 5.

In FIG. 1, the controller 5 includes a data storage unit 5a, an image storage unit 5b, and a process determination unit 5c. The data storage unit 5a stores a variety of data such as data of a drawing pattern corresponding to an applied area of the paste Pst on the substrate Pb and determination conditions corresponding to the drawing pattern, in addition to a program in which a procedure of applying the paste Pst onto the substrate Pb in accordance with a predetermined drawing pattern and a procedure of inspecting an application state of the paste Pst applied onto the substrate Pb in the drawing pattern are recorded. Image data acquired by the imaging of the camera 4 is input to and stored in the image storage unit 5b. The process determination unit 5c performs an image recognition process based on the image data stored in the image storage unit 5b and a determination process on the image recognition process result.

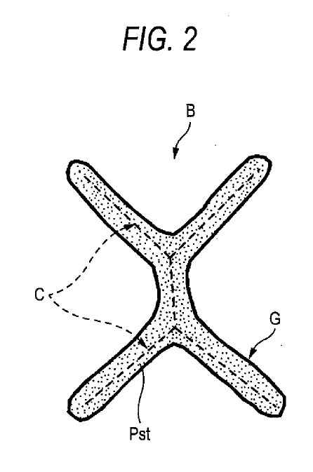

The data of the drawing pattern includes data of the movement procedure (moving path and moving speed) of the dispenser 3 relative to the substrate Pb and the ejection speed of the paste Pst from the dispenser 3. For example, when it is intended to form the paste Pst of the drawing pattern B shown in FIG. 2 on the substrate Pb, the paste Pst is ejected from the dispenser 3 at an appropriate ejection speed while moving the dispenser 3 along the drawing line C (line indicated by a dotted line in FIG. 2) of the drawing pattern B.

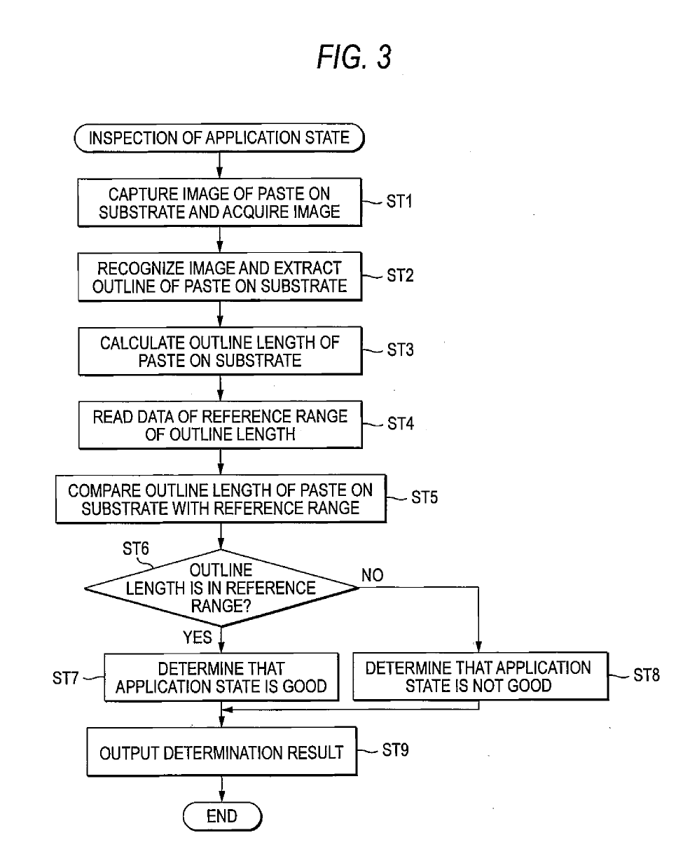

In inspecting an application state, it is inspected whether the paste Pst applied onto the substrate Pb is in the application state corresponding to a predetermined drawing pattern. To perform the inspection, the controller 5 actuates the substrate carrying path 2 to carry the substrate Pb having the paste Pst applied thereon by the dispenser 3 and to locate the substrate at a predetermined position, and actuates the camera moving mechanism 21 to locate the camera 4 just above the paste Pst on the substrate Pb (FIG. 1). When the camera 4 is located just above the paste Pst on the substrate Pb, the controller 5 controls the camera 4 to perform the imaging operation and controls the camera 4 to capture the image of the paste Pst on the substrate Pb. The acquired image data of the paste Pst is stored in the image storage unit 5b (step ST1 in FIG. 3).

When the image data of the paste Pst on the substrate Pb is stored in the image storage unit 5b, the controller 5 (process determination unit 5c) performs an image recognition based on the detection of brightness on the stored image of the paste Pst and extracts an outline G (solid line shown in FIG. 2) of the paste Pst on the substrate Pb (step ST2 in FIG. 3). Specifically, when the brightness of a pixel constituting the acquired image data is the brightness corresponding to the paste Pst, it is determined that the paste Pst exists at the position on the substrate Pb corresponding to the pixel. When the brightness of a pixel is not the brightness corresponding to the paste Pst, it is determined that the paste Pst does not exist at the position on the substrate Pb corresponding to the pixel.

When extracting the outline G of the paste Pst on the substrate Pb in this way, the controller 5 (process determination unit 5c) calculates the length (outline length) of the outline G (step ST3 in FIG. 3), and then reads a determination condition corresponding to the drawing pattern of the paste Pst which is a present inspection target, that is, data of a reference range of the outline length determined depending on the drawing pattern of the paste Pst which is a present inspection target (step ST4 in FIG. 3). The calculated outline length of the paste Pst is compared with the reference range of the outline length of the drawing pattern corresponding to the paste Pst which is a present inspection target (step ST5 in FIG. 3), and it is determined whether the outline length of the paste Pst is in the reference range (step ST6 in FIG. 3).

In this determination, when it is assumed that the calculated outline length of the paste Pst is, for example, L0 and the reference range corresponding to the drawing pattern of the paste Pst is, for example, from L1 to L2, and when L1≦L0≦L2 is satisfied, the outline length L0 of the paste Pst as the inspection target is in the reference range and thus it is determined that the application state of the paste Pst is good (step ST7 in FIG. 3). On the other hand, when L0<L1 or L0>L2 is satisfied, the outline length L0 of the paste Pst as the inspection target departs from the reference range and thus it is determined that the application state of the paste Pst is not good (step ST8 in FIG. 3). The controller 5 outputs the determination result (the inspection result of the application state of the paste Pst) to a display device 30 (FIG. 1) connected to the controller 5 (step ST9 in FIG. 3).

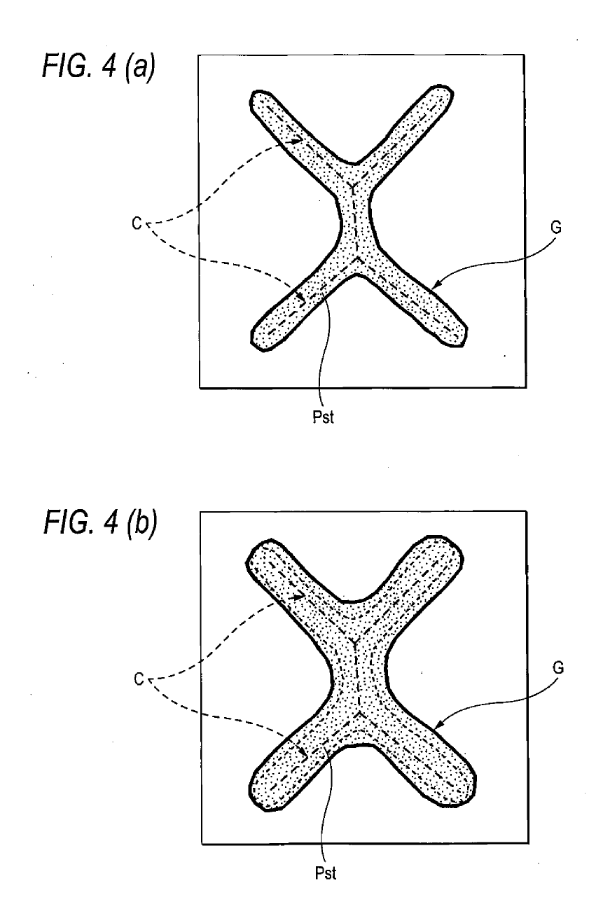

According to this application state inspecting method, for example, as shown in FIG. 4(a), the paste Pst spreads with the passing of time after an appropriate amount of paste Pst is applied. Accordingly, as shown in FIG. 4(b), even when the width of the paste Pst along the drawing lines C increases (the height of the paste Pst is lowered as a whole as much), it can be determined that the application state is good.

This is because an algorithm of determining that the application state is good when the outline length of the applied paste Pst is in the reference range is employed, on the basis of the fact that the length (outline length) of the outline G does not greatly vary even when the width of the paste Pst along the drawing lines C varies (increases) before and after the applied paste Pst is spread (the influence of the variation in length of a long side on the variation of the entire outline length is negligibly small when the spreading directions in the long side and the short side are homogeneous).

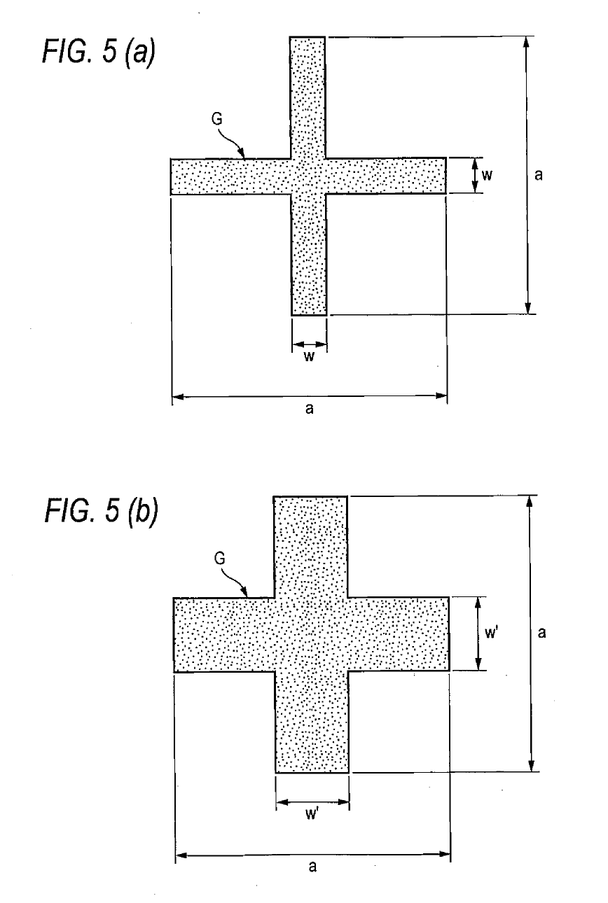

It can also be seen that the outline length of the paste Pst before the applied paste Pst is spread and the outline length of the paste Pst after the applied paste is spread are not greatly different from each other, from the fact that the cross shape shown in FIG. 5(a) and the cross shape shown in FIG. 5(b) are equal to each other as “a” in vertical size and lateral size, and the thicknesses thereof are “w” in FIG. 5(a) and “w′ (>w)” in FIG. 5(b), respectively, which are different, but the length (outline length) of the outline G of the cross shape shown in FIG. 5(a) and the length of the outline G of the cross shape shown in FIG. 5(b) are equal to each other as “4Xa”.

In this inspection method, the outline G of the paste Pst applied onto the substrate Pb can be extracted. Accordingly, when the paste Pst is formed of a material making the reflection of light in the central top portion uneven in the state where it is applied onto the substrate Pb, the inspection precision is not affected, thereby obtaining an accurate inspection result.

When it is determined in the application state inspecting method that the application state of the paste Pst is not good, it is thought that any one unit of the paste applying device 1 is out of order. Accordingly, an operator checks the paste applying device 1 at this time. On the other hand, when it is determined that the application state of the paste Pst is good, the substrate Pb having the paste Pst applied thereon is sent to a die bonding step which is a subsequent step.

According to the above-mentioned embodiment of the invention, the application state inspecting method of inspecting an application state of the paste Pst which is the viscous material applied onto the substrate Pb as the application target in a predetermined drawing pattern includes: the step (step ST1) of capturing an image of the paste Pst applied onto the substrate Pb and acquiring the image; the step (step ST2) of extracting the outline G of the paste Pst applied onto the substrate Pb on the basis of the acquired image; the step (step ST3) of calculating the outline length of the paste Pst from the extracted outline G of the paste Pst; the steps (steps ST5 and ST6) of comparing the calculated outline length of the paste Pst with the reference range of the outline length determined depending on the drawing pattern of the paste Pst and determining whether the outline length of the paste Pst is in the reference range; and the steps (steps ST7 and ST8) of determining the application state of the paste Pst on the basis of the determination result of whether the outline length of the paste Pst is in the reference range.

In the application state inspecting method according to the embodiment of the invention, since the outline G of the paste Pst applied onto the substrate Pb is extracted on the basis of the image acquired by capturing the paste Pst applied onto the substrate Pb in a predetermined drawing pattern and the application state of the paste Pst is determined on the basis of whether the outline length of the paste Pst calculated from the extracted outline G of the paste Pst is in the reference range of the outline length determined depending on the drawing pattern of the paste Pst, it is possible to obtain an accurate inspection result of the application state of the paste Pst on the substrate Pb even when the paste Pst is an easily-spreading material or a material making the reflection of light uneven.

It is possible to provide an application state inspecting method which can acquire an accurate inspection result of an application state onto an application target even when a viscous material is an easily-spreading material or a material easily making the reflection of light uneven.

### [FIG. 1]

Pst: BONDING PASTE

Pb: SUBSTRATE

### [FIG. 2]

G: OUTLINE

### [FIG. 3]

INSPECTION OF APPLICATION STATE

ST1: CAPTURE IMAGE OF PASTE ON SUBSTRATE AND ACQUIRE IMAGE

ST2: RECOGNIZE IMAGE AND EXTRACT OUTLINE OF PASTE ON SUBSTRATE

ST3: CALCULATE OUTLINE LENGTH OF PASTE ON SUBSTRATE

ST4: READ DATA OF REFERENCE RANGE OF OUTLINE LENGTH

ST5: COMPARE OUTLINE LENGTH OF PASTE ON SUBSTRATE WITH REFERENCE RANGE

ST6: IS OUTLINE LENGTH IN REFERENCE RANGE?

ST7: DETERMINE THAT APPLICATION STATE IS GOOD

ST8: DETERMINE THAT APPLICATION STATE IS NOT GOOD

ST9: OUTPUT DETERMINATION RESULT

END

What is claimed is:

1. An application state inspecting method of inspecting an application state of a viscous material applied onto an application target in a predetermined drawing pattern, comprising the steps of:
capturing an image of the viscous material applied onto the application target and acquiring the image;
extracting an outline of the viscous material applied onto the application target on the basis of the acquired image;
calculating an outline length of the viscous material from the extracted outline of the viscous material;
comparing the calculated outline length of the viscous material with a reference range of the outline length that is determined depending on the drawing pattern of the viscous material and determining whether the outline length of the viscous material is in the reference range; and
determining the application state of the viscous material on the basis of the determination result on whether the outline length of the viscous material is in the reference range.
